(19) United States
(12) Patent Application Publication
(10) Pub. No.: US 2011/0184899 A1
(43) Pub. Date: Jul. 28, 2011

(54) METHOD AND SYSTEM FOR GENERATING RECOMMENDATIONS OF CONTENT ITEMS

(75) Inventors: Sandra Gadanho, Reading (GB); Craig Watson, Southhampton (GB)

(73) Assignee: MOTOROLA, INC., Schaumburg, IL (US)

(21) Appl. No.: 12/738,376

(22) PCT Filed: Sep. 23, 2008
(86) PCT No.: PCT/US08/77326

§ 371 Date: Apr. 16, 2010

(30) Foreign Application Priority Data
Oct. 17, 2007 (GB) 0720294.8

(51) Int. Cl. G06N 5/02

(52) U.S. Cl. 706/46

(57) ABSTRACT

A recommendation system comprises a recommendation server (107) which generates a first recommendation set of recommended content items in response to a user profile associated with a first user and stored on the recommendation server (107). Content item identification data identifying the content items of the first recommendation set are transmitted to a first recommendation device (101). The first recommendation device (101) comprises a network interface (301) which receives the content item identification data from the recommendation server (107). A content list processor (303) determines the first recommendation set in response to the content item identification data. The first recommendation device (101) furthermore comprises application processors (309-313) which can execute different recommendation applications. A device recommender (307) generates a second set of recommended content items from the first recommendation set in response to a characteristic of the recommendation application being executed. The application then provides recommendations in response to the second set.

### FIELD OF THE INVENTION

The invention relates to a method and system for generating recommendations of content items, and in particular, but not exclusively to generation of recommendations of television programs.

### BACKGROUND OF THE INVENTION

In recent years, the availability and provision of multimedia and entertainment content has increased substantially. For example, the number of available television and radio channels has grown considerably and the popularity of the Internet has provided new content distribution means. Consequently, users are increasingly provided with a plethora of different types of content from different sources. In order to identify and select the desired content, the user must typically process large amounts of information which can be very cumbersome and impractical.

Accordingly, significant resources have been invested in research into techniques and algorithms that may provide an improved user experience and assist a user in identifying and selecting content, personalizing services etc.

As an example, television recommender systems are becoming a popular way to help people navigate a large and increasing number of program options in order to find the programs that fit their individual (or family group) preferences. For example, Digital Video Recorders (DVRs) or Personal Video Recorders (PVRs) which comprise functionality for providing recommendations of television programs to the user based on user preferences are becoming increasingly popular. More specifically, such devices can comprise functionality for monitoring the viewing/recording preferences of a user. These preferences can be stored in a user profile which subsequently can be used to autonomously select and recommend suitable television programs for viewing or recording. E.g. a DVR may automatically record programs which are then recommended to the user, for example by inclusion of the automatically recorded programs in a listing of all the programs recorded by the DVR.

In order to enhance the user experience, it is advantageous to personalise the recommendations to the individual user as much as possible. In this context, a recommendation typically consists in predicting how much a user may like a particular content item and recommending it if it is considered of sufficient interest. The process of generating recommendations requires that user preferences have been captured so that they can be used as input data by the prediction algorithm.

Recommender systems use different approaches to infer the user's preferences but usually share the common goal of attempting to identify the television programs from a list of available programs that best match the individual preferences of the user(s). The programs are typically selected from a list of the programs that have been announced for broadcasting in a future time window (typically, one week). The role of the recommender system is often to reduce this list to a smaller, more manageable, subset list that highlights the programs that best match the users' personalized preferences.

In many applications, the recommendations are generated independently by individual devices, such as a PVR or a television. Such an approach may allow a flexible and highly customised recommendation to be provided but also requires that each individual device comprises the required recommendation functionality. As many devices have limited computational resources, this tends to reduce the recommendation algorithms to relatively simple algorithms and/or to increase the cost of each individual device. Furthermore, it limits the recommendation to be based on information that is locally available to the device. This typically restricts the recommendation to be based on a user profile for only the user(s) of the specific device and prevents collaborative recommendations wherein the recommendation takes into account preferences of a larger group of users.

For various reasons, such as a lack of computational power of the individual device or the need to aggregate information from different users such as for collaborative recommenders, the computation of recommendations is thus often performed on a central server and then distributed to the local device(s) that the user interacts with.

However, such a centralised approach requires that data is either exchanged between the server and the device whenever the device needs to present recommendations to the user or requires that recommendations are frequently sent to the device(s) so that they are readily available when needed.

However, a problem with the first approach is that it results in a delay in the generation of the recommendation resulting in the recommendation application appearing slow to the user. Also, the approach requires a high communication capacity and can use substantial communication resources. The disadvantages make the approach impractical in many scenarios and in particular when the communication channel between the device(s) and the server is a limited or slow resource (e.g., for mobile devices).

A problem with the second approach is that the presentation of recommendation information is limited to the actual recommendations that have been received. Thus, the recommendations tend to be general recommendations for the time interval and the approach tends to result in more general and less adapted recommendations being generated. Also, the flexibility in providing different recommendations to the user(s) tends to be significantly limited and the approach tends to result in a suboptimal user experience.

Hence, an improved recommendation system would be advantageous and in particular a system allowing increased flexibility, facilitated implementation, increased response speed, improved user experience, reduced communication requirements, reduced computational resource demands, collaborated recommendations and/or improved recommendations would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided method of generating recommendations for content items in a recommendation system comprising a recommendation server and at least a first recommendation device, the method comprising: the server performing the steps of: generating a first recommendation set of recommended content items in response to a first user profile associated with a first user, and transmitting content item identification data to at least the first recommendation device, the content item identification data comprising a content item identification for each content item of the first recommendation set; and at the first recommendation device performing the steps of: receiving the content item identification data from the recommendation server, determining the first recommendation set in response to the content item identification data, executing a first recommendation application from a set of recommendation applications, each application of the set of recommendation applications being operable to provide recommendations, and generating a second recommendation set of recommended content items from the first recommendation set in response to a characteristic of the first recommendation application; and the first recommendation application providing recommendations in response to the second recommendation set.

The invention may provide an improved recommendation system. A flexible recommendation may be provided which is optimised for the specific application. A reduced computational resource usage for the server and/or the first recommendation device may be achieved in many embodiments. A reduced communication resource for communication between the server and the first recommendation device may be achieved. A high degree of flexibility, customisation and/or adaptation of the recommendation to the current conditions may be achieved. An increased responsiveness to a recommendation request can be achieved as the recommendations can be provided based on local computation at the first recommendation device.

The invention may in particular in many embodiments provide an improved and/or more flexible trade-off between advantages of a centralised and a distributed recommender approach. In particular, the invention may in many embodiments allow a fast, efficient and/or improved targeting of recommendations to individual requirements of each of a plurality of applications while providing advantages of a centralised recommendation approach. For example, collaborative recommendations can quickly and efficiently be adapted to the characteristics of a specific application. The approach may allow a plurality of recommendation applications using different recommendation parameters and/or algorithms to be implemented in a single device without requiring a corresponding high complexity and/or computational resource usage.

It will be appreciated that the generation of the second recommendation set may be performed by the first recommendation application. The second recommendation set may be a recommendation set generated by the first recommendation application and presented to a user. Specifically, the second set may be a subset of the first recommendation set and/or may be a rearrangement or reprioritisation of the content items of the first recommendation set.

Content item identification data may be transmitted to the first recommendation device at given update time intervals, such as e.g. daily, and may relate to a different time interval, such as a week. Within each update time interval, the generation of the second set may be in response to a current value of characteristics which vary within the update time interval.

The content items may for example be content items transmitted to the first recommendation device in accordance with a given transmission schedule and may specifically be television programs.

According to another aspect of the invention there is provided a system for generating recommendations of content items comprising: a server arranged to perform the steps of: generating a first recommendation set of recommended content items in response to a first user profile associated with a first user, and transmitting content item identification data to at least the first recommendation device, the content item identification data comprising a content item identification for each content item of the first recommendation set; and at a first recommendation device arranged to perform the steps of: receiving the content item identification data from the recommendation server, determining the first recommendation set in response to the content item identification data, executing a first recommendation application from a set of recommendation applications, each application of the set of recommendation applications being operable to provide recommendations, and generating a second recommendation set of recommended content items from the first recommendation set in response to a characteristic of the first recommendation application; and the first recommendation application is arranged to provide recommendations in response to the second recommendation set.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a distributed recommendation system in accordance with some embodiments of the invention;

FIG. 2 illustrates an example of a recommendation server in accordance with some embodiments of the invention;

FIG. 3 illustrates an example of a recommendation device in accordance with some embodiments of the invention;

FIG. 4 illustrates an example of a method of operation for a recommendation server in accordance with some embodiments of the invention;

FIG. 5 illustrates an example of a method of operation for a recommendation device in accordance with some embodiments of the invention; and

FIG. 6 illustrates an example of a method of operation for a recommendation device in accordance with some embodiments of the invention.

### DETAILED DESCRIPTION OF SOME EMBODIMENTS OF THE INVENTION

The following description focuses on embodiments of the invention applicable to a recommendation system for recommending television programs. However, it will be appreciated that the invention is not limited to this application but may be applied to many other recommendation systems.

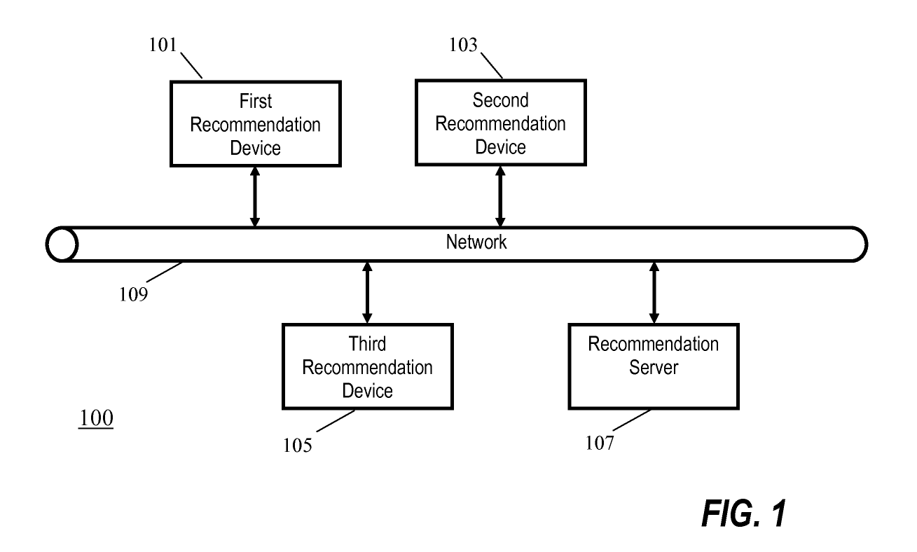

FIG. 1 illustrates an example of a distributed recommendation system in accordance with some embodiments of the invention.

The recommendation system comprises a plurality of recommendation devices 101, 103, 105. Each of the recommendation devices 101, 103, 105 comprises a plurality of applications which are capable of generating recommendations of television programs and presenting them to users of the devices 101, 103, 105. The recommendation devices 101, 103, 105 may for example be televisions, personal video recorders, etc.

The system furthermore comprises a recommendation server 107 which is operable to perform various centralised recommendation operations and algorithms as will be described later.

The recommendation devices 101, 103, 105 are coupled to the recommendation server 107 via a network 109 allowing data communication between the recommendation devices 101, 103, 105 and the recommendation server 107. The network may for example comprise a traditional phone system, mobile cellular communications and/or the Internet.

In the system, each of the recommendation devices 101, 103, 105 may perform a plurality of recommendation applications that provides recommendations of television programs to the user(s) of the device. In addition, the recommendation server 107 is arranged to execute a recommendation algorithm to generate a set of recommendations of television programs that suit a user or a group of users. Specifically, the recommendation server 107 stores one or more user profiles and may use advanced recommendation algorithms to select a first recommendation set of television programs. The selected set reflects the user's (or users') preferences but may typically be a relatively large set reflecting more fundamental preferences. In particular, the set may reflect an average set of preferences for a plurality of users and/or a set of long term preferences.

The recommendation server 107 transmits content item identification data that identifies the content items of the first recommendation set to one or more of the recommendation devices 101, 103, 105. The recommendation devices 101, 103, 105 then use the first recommendation set as the basis for a further customisation of the recommendations. This customisation depends on the characteristics of the individual recommendation application used to provide the recommendations to the user.

Thus, the system uses a distributed two stage recommendation process wherein a centrally generated first recommendation set is subsequently refined to match the specific application characteristics in the individual recommendation devices 101, 103, 105. This approach may reduce the computational requirements for the individual device, reduce the communication resource usage, improve the speed of response, allow complex recommendation algorithms to be used and/or enable centralised information to be used. In particular, the approach allows the individual recommendation devices 101, 103, 105 to employ a plurality of advanced and diverse recommendation applications with reduced resource usage.

Thus, the recommendation process is divided into two phases. The first phase is performed centrally and may be similar to traditional recommenders that produce a recommendation list. The second phase is executed in the individual device and re-arranges this list depending on the specific application which is executed from the set of possible applications at the device. The first phase is executed periodically to cover a future time window while the second phase is executed whenever a new recommendation is needed, and can specifically re-arrange the list from the recommendation server 107 to address a current interface context etc.

The approach thus allows intensive computation tasks to be performed only once while still providing varied recommendation experiences. It also allows intensive computation to be located in a server while allowing a local device the flexibility of providing multiple recommendations experiences while minimizing the communication between the two (as e.g. updated recommendation lists can be transmitted with long time intervals).

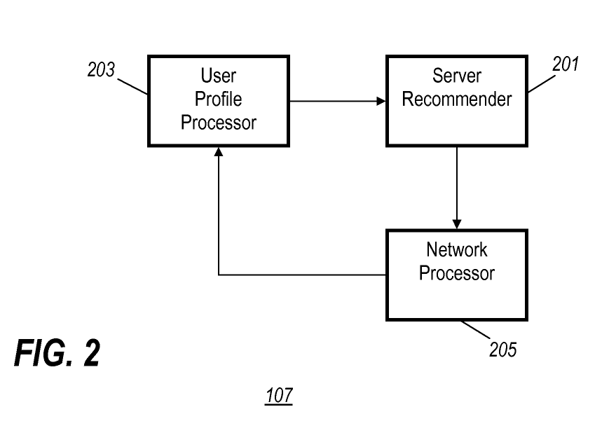

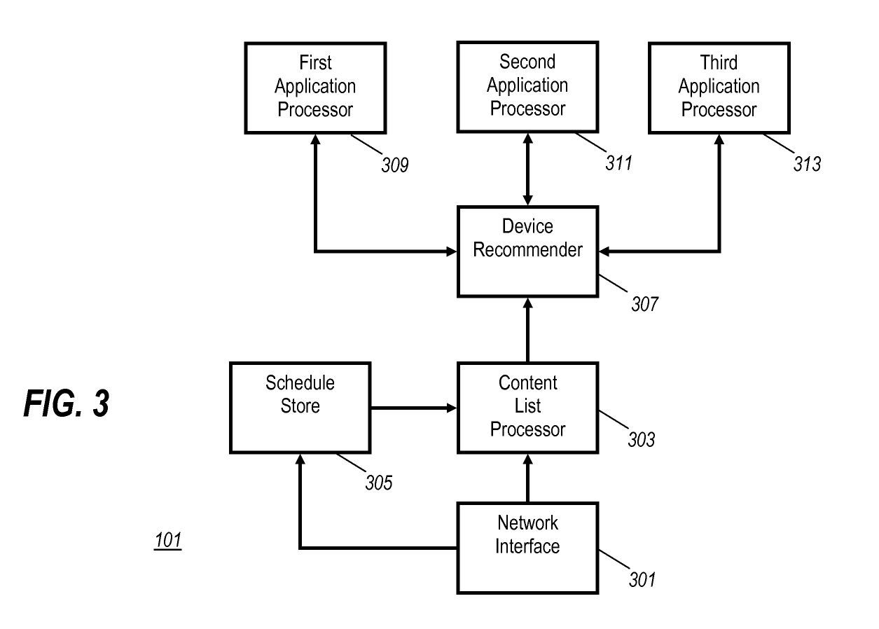

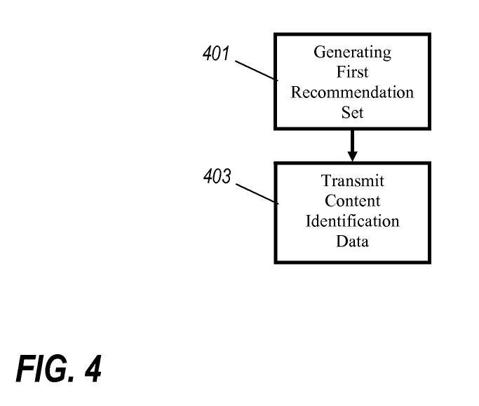

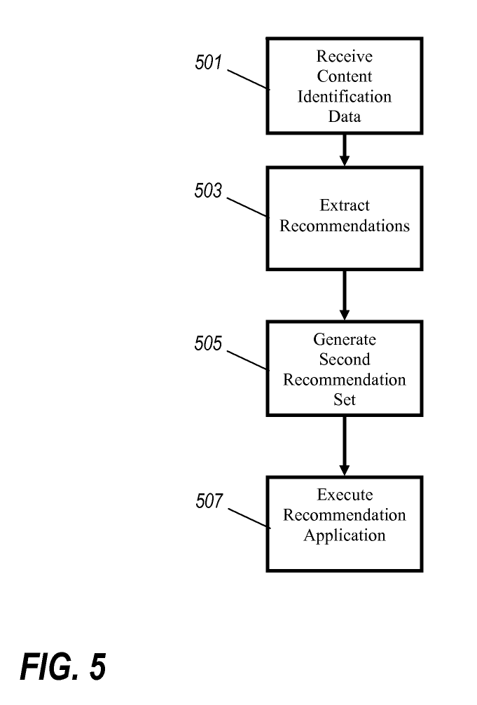

FIG. 2 illustrates more details of the recommendation server 107 of FIG. 1 and FIG. 3 illustrates more details of the first recommendation device 101. FIGS. 4 and 5 illustrate a method of operation for the recommendation server 107 and the first recommendation device 101 respectively. The operation of the system of FIG. 1 will be described in more detail with reference to these figures.

The recommendation server 107 comprises a server recommender 201 which is arranged to perform step 401 wherein a first recommendation set of recommended content items is generated in response to a server user profile associated with a first user. The server recommender 201 is coupled to a user profile processor 203 which stores and manages one or more user profiles for use by the server recommender 201.

The server recommender 201 and user profile processor 203 are coupled to a network processor 205 which is arranged to perform step 403 wherein content item identification data comprising a content item identification for each content item of the first recommendation set is generated. The content item identification data is then transmitted to at least the first recommendation device 101. In the specific example, the content item identification data is transmitted to all recommendation devices 101, 103, 105.

The server recommender 201 produces a first recommendation set which comprises content item recommendations from the content which is available to the user(s) of the recommendation devices 101, 103, 105. In the television recommendation domain of the specific example, this typically consists in selecting the television programs that particularly match the user(s) preferences from a provided television schedule. The recommendation algorithm will look ahead in this schedule for a given time interval which depends on the specific example. In the specific case, the server recommender 201 generates a first recommendation set which comprises recommended television programs for the next week.

In the example, the server recommender 201 limits the first recommendation set to television programs which are available to the recommendation devices 101, 103, 105 and specifically the server recommender 201 can limit the recommended set to each of the recommendation devices 101, 103, 105 to the programs of channels which can be received by the individual recommendation devices 101, 103, 105.

The server recommender 201 generates the first recommendation set such that it comprises a set of recommended programs which are of relevance to all the recommendation applications that may be performed in the individual recommendation devices 101, 103, 105. Thus, the recommendation algorithm of the server recommender 201 is set to generate a relatively broad set of recommendations which match the user's preferences but at the same time is not too limiting for different recommendation applications.

It will be appreciated that many different recommendation algorithms for generating content item recommendations in response to a user profile will be known to a person skilled in the art and that any suitable method may be used by the server recommender 201 without detracting from the invention.

As an example, the server recommender 201 may use a recommendation algorithm such as the algorithm presented in Jonathan L. Herlocker , Joseph A. Konstan , Al Borchers , John Riedl, “An algorithmic framework for performing collaborative filtering”, Proceedings of the 22nd annual international ACM SIGIR conference on Research and development in information retrieval, p.230-237, Aug. 15-19, 1999, Berkeley, Calif., United States.

In the example, the user profile stored in the server is a group user profile which has been determined in response to the preferences of a group of users. For example, user preferences may be obtained from a selected group of users or for all users associated with the recommendation server 107. The recommendation server 107 can then determine the group user profile for a user of the first recommendation device to take into account preferences of other users. Accordingly, the first recommendation set generated by the recommendation server 107 may be based on a collaborative recommendation and thus may contain content items that are partly selected as a consequence of a preference of other users in the group.

The recommendation algorithm of the server recommender 201 may favour programs that are scheduled in the user's favourite channels or viewing times. This may allow an improved adaptation to the user's preferences and increases the probability that the final recommendations to the user generated by a recommendation application of the recommendation devices 101, 103, 105 will be transmitted at times when the user typically views such content.

For example, the server recommender 201 may add less-preferred programs to the first recommendation set if they are transmitted at a peak viewing time for the user (e.g. a program having a recommendation value below the threshold for including it in the first recommendation set may still be included if it is transmitted at a preferential time). Such an approach may ensure that there is at least one program to recommend to a user during the peak viewing times for the user. Typically, such a program would be given a low preference/priority value in the generated first recommendation set.

In the example, the server recommender 201 not only generates a list of recommended content items but also generates an associated user preference indication for each content item. This indication is indicative of how closely the content item matches the user profile and/or is a measure of the preference for the content item that the user may have (it can e.g. be a predicted user rating for the content item). In the example, the network processor 205 is arranged to include this information in the content item identification data which is transmitted to the recommendation devices 101, 103, 105. The associated user preference indication may for example indicate a priority value for each content item in a prioritised first recommendation set wherein a higher priority is indicative of a higher probability that the user will like the specific content item.

In some embodiments, the content item identification data comprises a transmission time indication for at least one of the recommended content items. The transmission time indication may specifically indicate the time at which the particular television program is transmitted. Thus, in such an example, the items of the first recommendation set are event items which not only specify the content items but also when these are made available. This may facilitate operation at the recommendation devices 101, 103, 105 as these can directly process the first recommendation set to generate a specific recommendation to the user taking into account the specific transmission times of the television programs.

In other examples, the content item identification data does not comprise a transmission time indication for at least one content item of the first recommendation set. Specifically, the content item identification data may comprise only content item identifiers without any indication of the transmission times of the content items. Thus, the elements of the first recommendation set may simply be content item elements rather than event items. For example, if a specific television program is transmitted three times in the next week, the first recommendation set may comprise only a single identification of the program.

In such an example, each of the recommendation devices 101, 103, 105 may determine the actual transmission time(s) of the television programs in response to an identification of the content items and a locally stored table of transmission times for content items. Specifically, an identification of a television program can be used to perform a look up in a television schedule to identify the channel(s) and time(s) at which the program is transmitted. In such an example, a single content item entry in the first recommendation set may be expanded to a plurality of event items which are then used by the recommendation devices 101, 103, 105.

Thus, in the content item identification data, the first recommendation set may be expressed in terms of content only identifiers or schedule event identifiers. The former approach allows a reduction in the size of the content item identification data thereby reducing the communication resource usage, but may also increase the complexity and/or computational resource of the recommendation devices 101, 103, 105.

In some embodiments, the transmission time may indicate a preferred transmission time. The recommendation devices can then determine alternative transmission times from a locally stored TV schedule.

The recommendation server 107 typically produces a first recommendation set that covers all possible options likely to be used by a recommendation algorithm of the recommendation devices 101, 103, 105. However, the first recommendation set is a substantial reduction of the total amount of available content thereby reducing the computational requirement for the recommendation devices 101, 103, 105. Also, generating a relatively short first recommendation set reduces the communication resource usage and thus the bandwidth requirement for the communication between the recommendation server 107 and the recommendation devices 101, 103, 105. In order to reduce the amount of content item identification data transmitted, only the differences between the current first recommendation set and a previously transmitted first recommendation set may be transmitted (e.g., if a daily update of a first recommendation set covering a week is transmitted).

In the specific example, the recommendation server 107 generates a first recommendation set comprising content identifiers (or event identifiers) and their preference value/recommendation weight (Wᵢ). This set covers a time window ahead for a period T_{R} (typically, a week ahead). Updates of the set are periodically sent to the device. The time between updates T_{U} (typically a day) should be less than T_{R}. The set contains items that are of interest to the user according to the recommender predictions.

In the following, the operation of the first recommendation device 101 will be described in more detail with reference to FIGS. 3 and 5.

The first recommendation device 101 comprises a network interface 301 which executes step 501 wherein the content item identification data is received from the recommendation server 107.

The network interface 301 is coupled to a content list processor 303 which performs step 503 wherein the first recommendation set is extracted from the content item identification data.

In the specific example, the first recommendation set comprises content item identifications rather than event item identifications and the content item identification data does not comprise any indications of the transmission times of the content items. The content list processor 303 is however coupled to a schedule store 305 which comprises transmission time information for the content items (specifically it can comprise a television schedule for the coming week). The content list processor 303 retrieves the transmission time(s) for each television program of the first recommendation set and uses this to generate event items from the received content items.

Thus, in such an example, the content list processor 303 determines transmission times for the content items in response to content item identifications in the content item identification data and a locally stored table of transmission times for content items (such as a stored television schedule).

The content list processor 303 is in the example coupled to a device recommender 307 which is operable to perform step 505 wherein a second recommendation set of recommended content items is generated from the first recommendation set. The second set may consist of a smaller and more targeted recommendation set than the first set.

The device recommender 307 is coupled to three different application processors 309, 311, 313. Each of these is operable to execute a recommendation application as represented by step 507.

Thus, the first recommendation device 101 comprises functionality for performing a plurality of different recommendation applications which have different characteristics such as different user interface/presentation characteristics etc.

The device recommender 307 is arranged to generate a second recommendation set in response to a characteristic of the first recommendation application. In the specific example, the application processors 309-313 can request a set of recommendations from the device recommender 307 and depending on which application processor 309-313 requests the recommendations, the device recommender 307 proceeds to generate the second recommendation set using different parameters and/or constraints for the recommendation process. Thus, depending on which application processor 309-313 requests a set of recommendations, the device recommender 307 generates different sets of recommendations. In the example, the application processor 309-313 then proceeds to use the provided second recommendation set in accordance with the specific application and specifically can proceed to present the provided second recommendation set to the user.

In the specific example, the application processors 309-313 thus do not comprise individual recommender functionality but all use the common recommendation functionality of the device recommender 307. However, the recommendation process/algorithm of the device recommender 307 is modified depending on the specific application.

In the example, the device recommender 307 may e.g. be implemented as a subroutine that can be called by any of the recommendation applications executed at the first recommendation device 101. The call of the recommendation subroutine can comprise a set of parameters that is applied to customise the recommendation for the calling application. These parameters may thus be the characteristic of the calling application which is used to customise the recommendation.

It will be appreciated that in other embodiments, each of the application processors 309-313 can include recommendation functionality for generating a second recommendation set. Thus, different functionality and recommendation processes/algorithms are used to generate the second recommendation set depending on which application is executed. In such an example, each of the application processors 309-313 may receive the first recommendation set from the content list processor 301 and individually generate a second recommendation set using the application specific recommendation process.

The first recommendation device 101 can thus dynamically optimise the generated recommendations based on the specific requirements and preferences associated with the application. For example, one application may be arranged to provide a recommendation for a program to be watched in a very short time interval from when the recommendation request is made. In response, the first application processor 309 can process the first recommendation set received from the recommendation server 107 to generate a targeted list aimed at providing recommendations of television programs that start very soon.

For example, the first application processor 309 may introduce a bias to the user preferences of the first recommendation set based on the transmissions times and a current time. This bias can result in a second recommendation set with changed priority or order of the content items of the first recommendation set. As a consequence, the first application may e.g. provide a recommendation to a viewer of a slightly less preferred program starting in a few minutes rather than a more preferred program starting in, say, an hour. However, by adjusting the bias appropriately, the first application may still recommend a program with a very high preference value starting in, say, 20 minutes over a much less preferred program starting in, say, 5 minutes.

A second application may generate a set of recommended content items covering a longer time interval of, say, a few days. In this case, the first recommendation set may be processed taking into account e.g. a users preferred viewing times. Thus, a completely different second recommendation set may be generated and presented to the user.

However, both applications are based on the first recommendation set which is substantially reduced in comparison to the total set of content items available to the user. Accordingly, a much faster and less resource demanding recommendation process can be implemented at the first recommendation device 101. In particular, the recommendation process of the first recommendation device 101 may simply be based on biasing the content item preferences of the first recommendation set generated by the recommendation server 107.

Accordingly, in some embodiments, the content item identification data received from the recommendation server 107 can comprise a preference indication for each content item reflecting the user preference for the content item predicted by the recommendation process of the recommendation server 107. In such embodiments, the generation of the second set of recommended content items can be in response to this associated user preference indication. For example, as described above, the device recommender 307 may introduce a bias to the received user preferences or may combine (e.g. by a weighted summation) locally generated user preferences using a locally stored user profile with the preferences from the recommendation server 107.

Specifically, the locally stored user profile may relate to a group of users which is a subset of the group of users which has had an impact on the user profile of the recommendation server 107. E.g. the user profile used for the recommendation in the recommendation server 107 may have been derived in response to more users than use the first recommendation device and may in particular have been derived in response to the content item selections/preferences of all users of all the recommendation devices 101, 103, 105 whereas the locally stored user profile may include the user preferences of only the users using the first recommendation device 101. Specifically, the locally stored user profile may be a single user profile. Thus, the system allows collaborative user preference based recommendations to be efficiently adapted to individual user preferences.

As another example, the locally stored user profile may be a more detailed user profile than the user profile used by the recommendation server 107. For example, the local user profile may comprise more accurate preferences, preferences for more categories and/or content item characteristics, more complex preference values (e.g. a set of preferences rather than a single preference value) etc. Such an approach may allow an improved targeting of the recommendations without requiring a centralised storage, generation and maintenance of a highly detailed user profile.

In some embodiments, the generation of the second set of recommended content items is in response to a content item presentation time preference of the user. For example, the first recommendation device 101 may monitor when the user typically views television programs and this may be captured in the local user profile. The preference value for a given television program of the first recommendation set may then be biased in the device recommender 307 depending on the value of the stored presentation time preference for the transmission time of the specific television program.

As another example, the locally stored user profile may contain information indicating how the users preferences changes with time. For example, it may reflect that a user tends to prefer to watch comedy programs early in the evening and to watch films late in the evening. Thus, the user profile can indicate the user's content item preferences for different time instants. The generation of the second set of recommended content items can then take this time varying preference into account. For example, the device recommender 307 may positively bias comedy shows early in the evening and films late in the evening. Thus, in such a system, a short term adaptation of recommendations to the time at which the recommendations are provided can be achieved without requiring the centralised recommendation server 107 to consider or be aware of such short term variations. Thus, a common and non-time dependent first recommendation set can be generated by the centralised recommendation thereby reducing or eliminating the need for frequent updates of the first recommendation set and/or reducing the size of the content item identification data as this does not need to include data representing the short term preference variations.

The recommendation by the device recommender 307 may for example be adapted depending on a user interface characteristic of the recommendation application requesting the recommendation set. For example, the generation of the second recommendation set may depend on how many content item recommendations the application is presenting to the user. Thus, the number of content items in the first recommendation set may be reduced for the second recommendation set e.g. simply by selecting the required number of content items that achieved the highest preference values in the recommendation.

As another example, the recommendation may be adapted in response to a content item presentation characteristic associated with the first application. For example, if the application recommends content items to be viewed in real time (i.e. when they are transmitted), the generation of the second recommendation set may take the user's viewing time preferences into account. However, if the application recommends content items for recording, the generation of the second recommendation set may ignore the viewing time preferences but instead apply the restriction to the second recommendation set that it must not contain overlapping programs.

In some examples, the recommendation may be adapted depending on a recommendation time interval characteristic of the application. For example, as exemplified above, if the application is providing recommendations for a short time interval around the current time, the generation of the second recommendation set will strongly bias television programs starting in the near future whereas if the application recommends television programs for the next several days, for the purpose of recording to local storage for later consumption, such a bias will not be introduced.

In the following, a specific example of a specific operation of the first recommendation device 101 will be described.

In the example, applications using different re-arrangement strategies for different interface interactions are used to generate the second recommendation set. The specific recommendation strategies described are particularly suited to typical user interaction with a television.

A first application, referred to as the cherry picker application, generates recommendations of the most preferred television programs (the “cherries”) in a period of a few days thereby allowing users to plan their viewing ahead of time by presenting the best set of recommendations for the period.

A second application, referred to as the now and next application, generates recommendations of television programs which are currently presented or which start within a short time window (say within the next fifteen minutes). Thus, this application helps the user decide what to watch now.

A third application, referred to as the recording application, generates recommendations of television programs for recording (and therefore is free from any known user viewing time restrictions) within the next, say, two days. Thus, this application helps the user decide what to record over the next days.

Depending on the specific application, the first recommendation set needs to be re-arranged either by eliminating programs that are not appropriate to the interaction context or by adapting the relative preference values to the specifics of the application.

As previously described, the first recommendation device 101 comprises server communication functionality which is capable of receiving a recommendation list (the first recommendation set) from the recommendation server 107.

When a new recommendation list is received from the recommendation server 107, the locally stored first recommendation set is updated (or replaced by the received list depending on whether content item identification data comprising a complete first recommendation set or only a differential first recommendation set is received). The content items of the list are then expanded to event items. Specifically, the content identifiers (CIDᵢ) are looked up in a local schedule (for a predetermined future time-window, typically within a week) and specific schedule events (SID) are generated. In some cases, the same content may be broadcasted more than once. In this case, one content entry will be transformed into multiple event entries.

The recommendation process is performed by the device recommender 307 based on the first recommendation set when a request is received from one of the applications.

Thus, the recommender process starts with the base recommendation list (the first recommendation set). The first step is to remove any schedule events that have already been transmitted. Specifically, content items are removed from the first recommendation set in response to a comparison of a current time and a transmission time for the content items (e.g. all items with SID values that indicate a schedule event in the past are removed). At this point, the base recommendation list can be updated so that these items do not have to be looked up again.

Depending on the application requesting the recommendations, a different selection strategy is applied:

### Now & Next Application Request

The recommendation list is restricted to the current time period, by selecting only those programs that will be transmitted in a short time interval (e.g., within the next hour). The generation of the second recommendation set may specifically take into account a mood score which reflects the user preference variations with time (e.g. it can reflect the user's current preference (e.g., the type of program the user is currently looking for)).

The mood score can e.g. be inferred from the user's previous viewing behaviour and can be stored in the user profile of the recommendation device 101. This can e.g., be modeled as the probability P_{mood}(c) of a certain content c matching the current mood. For example, it can be modeled in terms of the content similarity of content to other content cᵢ watched within the same viewing session some time eᵢ ago (A is a constant parameter of the system):

$${P}_{mood} ( c ) = {\prod }_{i} exp ( - λ {e}_{i} ) similarity ( c , {c}_{i} )$$

In a simple example, the similarity may be computed from the genres of the content being compared (e.g., similarity is 1 if the genre is the same and 0 otherwise). More sophisticated similarity measures could take other attributes into account.

Thus, for each content cᵢ of the first recommendation set, the device recommender 307 can take the mood score P_{mood}(cᵢ) into account to adjust the weight (Wᵢ) (preference value) for the content item. Thus, the weight of items with higher mood scores (Wᵢ=Wᵢ+αP_{mood}(cᵢ)) is increased and the second recommendation set can be generated by re-arranging the first recommendation set according to these new weight values.

### Cherry-Picker Application Request

For this application, the recommendation process will look further ahead in the future for schedule events (typically, it will start with all programs in the first recommendation set).

For each content cᵢ within the first recommendation set, the transmission time tᵢ is used to calculate a user preference for this time Pₜᵢₘₑ(tᵢ). Thus, the users viewing time preferences are used to modify the preference values.

Viewing information can be used to determine viewing time preferences. For example, the probability Pₜᵢₘₑ(t) of viewings being in a certain timeslot t within a week (e.g., every half an hour within the week) can be determined. This can be calculated as the number of times content has been viewed within that time slot t divided by the total number of times the user has viewed content within any time slot.

If the same content cᵢ is associated with different schedule events, the content transmitted at the most preferred time is selected and the other events are discarded (if the preference value is the same, the first transmission may be selected). The viewing time preference is then used to adjust the weight Wᵢ for the content (Wᵢ=Wᵢ+αPₜᵢₘₑ(tᵢ)) and the second recommendation set is generated by re-arranging the first recommendation set according to these new weight values.

### Recording Application Request

The recommendation of the device recommender 307 for this application can be similar to the cherry picker application but instead of adjusting the preference values in response to the preferred viewing times of the user, they are adjusted depending on the earliest transmission times and avoiding any recording clashes (i.e. the recommendation is constrained to ensure that there are not more programs scheduled for recording at any one time than the number of programs that the device can simultaneously record).

In some embodiments, the applications may add one or more content items to the second recommendation set. Thus, the applications may generate and present a recommendation list of content items which includes at least one content item not included in the second set. The selection of the additional content item(s) may for example be a random selection from the television schedule or may be selected as programs not included in the first recommendation set and/or the second recommendation set but which has some similarities to the content items of these sets (e.g. the same actor and/or genre).

Such an approach may add more options to the second recommendation set when few options are found within the first recommendation set that fit the criteria imposed by the application request.

The applications may also choose to select the items for the second recommendation list taking into account the diversity of the items selected. In such a case, the priority or weight of each content item can be adjusted in response to how similar they are to items already in the recommendation set.

In some embodiments, the first recommendation device 101 furthermore monitors user behaviour and updates the user profile in response to the behaviour.

Specifically, viewing information and content ratings can be collected by the first recommendation device 101 and used to update the user profiles. The user preference for a category to which a content item belongs may for example be increased if the content item is selected for viewing and/or if a positive user rating is received.

Thus, based on a selection or rating of a content item, a user preference indication can be generated (e.g. directly corresponding to the rating) and used to update the locally stored user profile. Alternatively or additionally, the user profile indication can also be transmitted to the recommendation server 107 where it can be used to update the user profile used for the centralised recommendation generating the first recommendation set.

The first recommendation device 101 may comprise functionality for dynamically updating the second recommendation set and/or the first recommendation set. E.g. if a television program has been viewed, it can be removed from the sets since the user is not likely to want to see the program again within the recommendation time window (T_{R}). If a particular program is negatively rated then further recommendations of this program may be avoided.

As another example, if the user rates some specific content very positively, this can be promoted within the first recommendation set and/or the second recommendation set (specifically, the associated weight value can be increased for the content item in view of the new rating and the content item can accordingly be repositioned within the second recommendation set).

Thus, the first recommendation can determine a user preference indication, such as a rating, for a content item in the second set. It may then proceed to modify a preference value for at least one content item in response to the user profile indication.

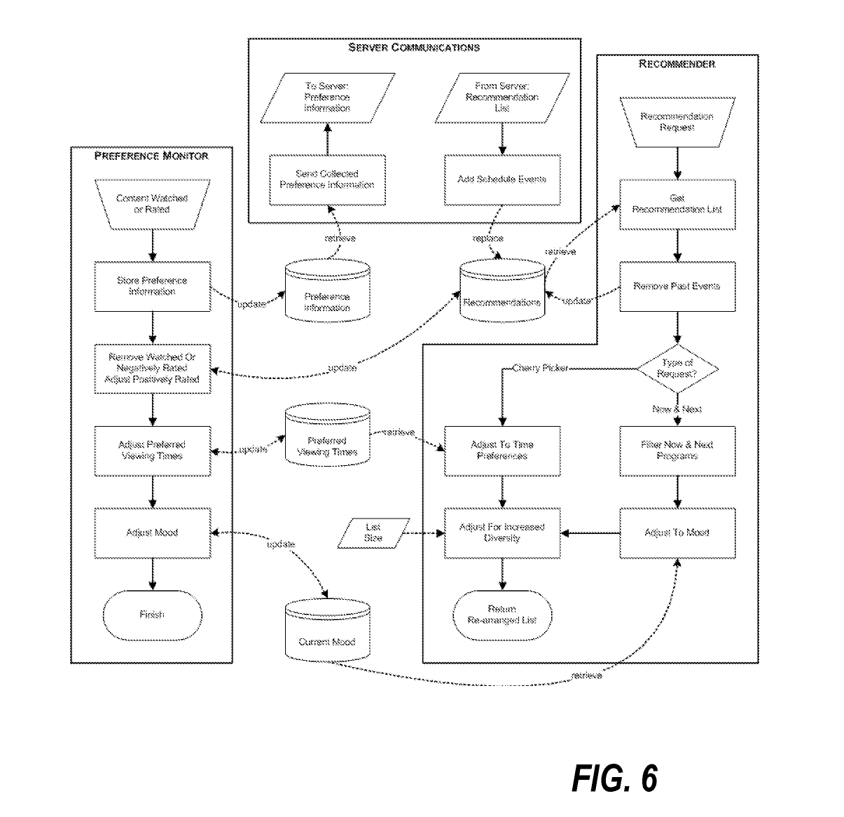

An example of a method of operation for a recommendation device in accordance with the previous description is shown in FIG. 6.

An advantage of the described approach is that new recommendation applications and interfaces can be added to a device without any extra communication cost or resource usage and with only minor added computational costs (since the bulk of the computation is already being made on the server).

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A method of generating recommendations for content items in a recommendation system comprising a recommendation server and a recommendation device, the method comprising:
at the recommendation server:
generating a first recommendation set of recommended content items in response to a first user profile associated with a user; and
transmitting content item identification data to the recommendation device, the content item identification data comprising a content item identification for each content item of the first recommendation set;
and at the recommendation device:
receiving the content item identification data from the recommendation server;
determining the first recommendation set in response to the content item identification data;
executing a recommendation application from a set of recommendation applications, each application of the set of recommendation applications being operable to provide recommendations; and
generating a second recommendation set of recommended content items from the first recommendation set in response to a characteristic of the recommendation application; and
the recommendation application providing recommendations in response to the second recommendation set.

2. The method of claim 1 wherein the content item identification data further comprises an associated user preference indication for at least one content item of the first recommendation set, the associated user preference indication being indicative of a server-estimated user preference for the at least one content item; and
wherein generating the second set of recommended content items is in response to the associated user preference indication.

3. The method of claim 1 wherein the content item identification data comprises a transmission time indication for at least one content item of the first recommendation set; and
wherein generating the second set of recommended content items is in response to the transmission time indication.

4. The method of claim 1 wherein the content item identification data does not comprise a transmission time indication for at least a first content item of the first recommendation set; and
wherein the recommendation device determines a transmission time for the first content item in response to a content item identification of the first content item and a locally stored table of transmission times for content items.

5. The method of claim 1 wherein the characteristic is a user interface characteristic of the recommendation application.

6. The method of claim 1 wherein the characteristic is a recommendation time interval characteristic of the recommendation application.

7. The method of claim 1 wherein the characteristic is a content item presentation characteristic of the recommendation application.

8. The method of claim 1 wherein the second recommendation set is a prioritised set of content items and
wherein the recommendation device prioritizes the content items of the second set.

9-11. (canceled)

12. The method of claim 1 wherein generating the second recommendation set is further in response to a content item presentation time preference of the user.

13-20. (canceled)
